(19) United States
(12) Patent Application Publication
(10) Pub. No.: US 2018/0204225 A1
(43) Pub. Date: Jul. 19, 2018

(54) Network Control Device

(71) Applicant: eBlocker GmbH, Hamburg (DE)

(72) Inventor: Christian Bennefeld, Hamburg (DE)

(21) Appl. No.: 15/739,715

(22) PCT Filed: Jun. 14, 2016
(86) PCT No.: PCT/DE2016/000249

§ 371 Date: Dec. 23, 2017

(30) Foreign Application Priority Data
Jun. 22, 2015 (DE) 10 2015 007 876.3

(51) Int. Cl. G06Q 30/02; H04L 29/08

(52) U.S. Cl. CPC G06Q 30/0201; H04L 67/22; G06Q 30/0277; H04L 67/42; H04L 67/02; H04L 67/20; H04L 67/28; G06Q 30/0251

(57) ABSTRACT

A network control device has at least one data communication interface for communication with a local area network and at least one memory device with resource information regarding advertising contents and analysis services. The network control device is programmed for transmission of data traffic of at least one client of the local area network to external servers; for analyzing outgoing requests on application protocol level by identifying resource information and by comparing with the stored resource information; for the forwarding of requests or the prevention thereof to external servers as a function of the result of the analysis or generating a dedicated response to a hindered request to the client; for analyzing incoming responses on application protocol level and identifying resource information and tracking information and for the forwarding or replacement of the responses to the client as a function of the result of the analysis.

### TECHNICAL SUBJECT AREA

The invention relates to a network control device for monitoring and control of advertising content and user-related data in internet data communication.

### PRIOR ART

For the monetization and financing of internet-based information and entertainment media, various forms of text, image, video or audio advertising (advertising media) are known, which are integrated in the media content in various forms and transmitted to the user with the retrieval of the medium and then presented together with this on the user's terminal equipment (client). When media (partial) content or advertising media integrated in websites or mobile apps are retrieved, the desired media content can also be accessed by third-party sources, which are not identical to the provider (content provider or publisher) of the media content desired by the user. Such third-party sources may be third-party traders (advertisers), ad servers, social media or advertising networks, which operate corresponding advertising spaces within the media content via technical interfaces in real-time, either directly or via other service providers. The websites or mobile app contents include, for example, placeholders for advertising as references (Adtags), which are filled with advertising when a page is retrieved. This allows different advertising media and advertising customers to rotate at the same place. Even today, online advertising (display, video, text) is incorporated in websites or mobile app content in ways specific to their subject area and delivered to the user of the website via Ad servers. Thus, users of a website A, which offers, for example, information on financial services such as stock exchange prices, etc., receive advertisement overlays related to similar products such as, for example, portfolio management or investment products. The advert bookings are usually placed by the advertising company (advertiser) directly with website A (content provider or publisher) or its marketer for a fixed period of time and/or for a specific number of users or pop-up advertisements. For the technical implementation of internet-based advertising and for technical coordination of the participating agencies and providers (content providers, advertisers, media agencies, advertising networks, Ad-server operators), international technical standards have been defined for advertising formats and processes by the IAB (Interactive Advertising Bureau).

The retrieval of each individual item of (partial) media content or advertising medium integrated into a website or mobile app content over the internet can also be logged by the respective source provider or an integrated web analytics service, or social media or advertising network. For this purpose, usually by the server from which the advertising medium is retrieved, cookies are set in the client, which can be read and used for identifying the client during a subsequent additional retrieval of advertising media. With the aid of these cookies and possibly JavaScript functions, in addition to the IP address of the retrieving client and the retrieved content, other technical features of the client (such as screen size, color depth, installed plug-ins, rendering time, etc.) can be read off, and all data additionally supplied by the client via HTTP or HTTPS in the protocol header can be collected and stored. With successive or repeated retrievals of (partial) media content or advertising media from identical sources, the client is identifiable by the respective source via cookies or on the basis of specific data representing the particular hardware and software environment of the client, or specific combinations of such data, and therefore logged data can be combined to form user profiles (tracking). A further method of recognizing visitors without the setting and reading of cookies is the technique of “Browser fingerprinting” (also called “Canvas fingerprinting”), in which a recognition is performed solely by the properties of the specific system installation that can be retrieved using the HTTP protocol (for example, the browser version used and any installed plug-ins and system fonts, etc.). Third-party providers, which are integrated into a large number of websites or mobile app-contents, such as media agencies, Ad-server operators, web analytics services or social media or advertising networks, can thus form extensive website user profiles and cross-session user profiles. The integration of pure technical service providers such as web analytics services is carried out, for example, via the integration of partial content items not visible to the user, for example, a color-neutral or transparent graphic which is small in size (count pixels, Webbug, Web Beacon or Zero Pixels). User profiles created in such a way can be used as a basis for personalized advertising forms and processes.

The use of such user profiles, in addition to the direct booking of advertising spaces, has allowed a new market for pop-up adverts to be established, which are not (or not only) aimed at the subject area of the site, but (also) at the behavior or interests of the respective user (so-called behavioral or interest-based advertising). The advertising spaces are auctioned off to the highest bidder by publishers in the so-called real-time advertising process (RTA) between the bidding advertisers. The publishers place the free advertising space (the so-called inventory) that is to be filled with advertising into an AdExchange or sell-side platform (SSP). The bid amount is specified by the respective advertiser based on the user profile data of the individual user visiting the website and negotiated using the AdExchange or the RTA system used. The user is usually recognized by the advertising platforms or advertisers via cookies. The assignment to the user profile takes place either via a unique user ID in the user cookie (normally an MD5 hash based on the email address of the user, if the user has a user account with the respective service provider), which is linked to a user profile database on the SSP (or on a connected Data Management Platform/DMP), or else the user profile is stored directly in the cookie itself. Currently, the user profiles are usually collected implicitly by the user being tracked by the websites they have visited, and their possible interest being thus derived. For example, if a user X visits the website A, which only offers financial services products, then X's user profile will contain a note on his interest in financial services products. This interest is often recorded in the form of probabilities, wherein the probability of an interest is calculated using stochastic methods from the number of visits and the number of topic-specific websites or web pages visited. Likewise, socio-demographic characteristics of the user are also extracted by implicit derivation, often making use of stochastic methods. If user X frequently visits web pages which are primarily oriented towards female target customers, then this increases the probability that this user is female. Since implicitly recorded user profile data are based on the websites visited and stochastic methods, it is never completely safe to assume that the data collected correspond to the real interests of the user. Cookies also have the disadvantage that they only mark the browser used, but not the actual user. If the browser is used by two or more members of the household, the user cannot be uniquely identified and the user profile data become very inaccurate and therefore worthless for targeted pop-up adverts in the RTA.

Advertising content which is integrated in websites or mobile app contents is often perceived as annoying by the users. Also, an uncontrolled collection, storage, aggregation, and analysis of the usage data collected is usually unwanted by the user. Also, the personalized advertising offered on the basis of user profiles in practice often does not match the actual interest or the actual preferences of the users. There is therefore a need to prevent unwanted advertising when using internet-based information and entertainment content, to protect personal privacy and to prevent the uncontrolled accumulation of personal or potentially personal data.

In the prior art, different approaches to the filtering of advertising and analysis and tracking services are known: auxiliary programs for browser applications, so-called plug-ins or add-ons, such as the well-known program under the brand name Adblock Plus for the suppression of advertising on web pages (ad blocker), or the program known by the brand name Ghostery for identifying and blocking analysis and tracking services on web pages. These plug-ins have the disadvantage that they each possess only one of the desired features and must be installed and configured separately by the user on every terminal device and for every browser application used. A central cross-device and cross-browser configuration, for example, to disable the Ghostery or Adblock function on a particular page (so-called whitelisting), is not possible. Their installation and, in particular, configuration, also assumes a basic technical understanding on the part of the user. In addition, these programs are not available for all terminal device platforms and browser applications. The well-known operating system sold under the brand name Apple iOS and a large number of Smart TVs and games consoles generally do not allow the installation of plug-ins. Finally, plug-ins per se are not suitable for use by multiple users and can only be used separately by multiple users by means of the user management of the respective terminal operating system. In addition to plug-ins, there are various proxy servers to be installed locally on the respective terminal, such as the programs known under the brand names webwasher or adGuard for the Microsoft Windows Operating System (brand name). These solutions also assume technical expertise on the part of the user for their installation and configuration. They have the advantage that all browsers on the terminal—after appropriate proxy configuration of the browser—can take advantage of the solution. However, these programs are also not available across all terminal device platforms and browser applications. Proxy server services on the internet, such as the service offered under the URL disconnect.me, have the advantage that they can be used by all devices and browsers that allow a configuration of a proxy server. The disadvantage of such a solution, however, is that all the user's internet traffic is routed through the proxy server. This slows down—depending on the location and the bandwidth of the proxy server service—the connection speed for internet access significantly. In addition, the proxy server service can also record the entire browsing history of the user, and assign it to the respective user's personal history via his login. In the case of proxy server services based abroad, the data exchange takes place outside the legal jurisdiction of the legal system that applies to the user. Finally, individual local hardware solutions exist for the user's domestic network, such as a central ad-blocker for the home network which is managed under the brand name AdTrap, or a router managed under the brand name invizBox for the gateway network connection to anonymize connection data. These devices also have the disadvantage that they only perform one specific function and do not allow the prevention of unwanted advertising and uncontrolled accumulation of personal or potentially personal data at the same time during the use of internet-based information and entertainment content. They also require a high level of technical effort for installation and configuration.

Document DE 10 2013 206 441 A1 discloses a network device for optimizing advertising content which is displayed in an internal network. The device intercepts outbound data packets from the internal network, analyzes them and detects requests for advertising content contained within them. An advertising profile generator generates a user profile, on the basis of which the requests for advertising content are further transferred in a modified form with the data packets. The modification includes the insertion of keywords, which are extracted from a keyword database or the user profile, into the advertising content requests. The user profile can be updated in relation to the user's activity based on the information obtained from the analyzed network traffic. Furthermore, the user profile can be designed to be configurable by providing a user interface. The network device disclosed by DE 10 2013 206 441 A1 is used for the optimization of advertising content by supplementing or modifying the requests for advertising content with keywords, which correlate with the user activity. DE 10 2013 206 441 A1 therefore teaches no concrete means or rules, with which or according to which the execution of advertising requests or the transmission of personal or potentially personal data to analysis and tracking services is prevented. It therefore allows no secure elimination of unwanted advertising and uncontrolled accumulation of personal or potentially personal data during the use of internet content, but only its content-related modification based on keywords correlating with the user activity. DE 10 2013 206 441 A1 also defines no specific initial content of the user profile, so that this is created only gradually using the information obtained on the basis of the analyzed network traffic relating to the user's activity. The automated generation of a user profile on the basis of the analyzed network traffic, however, has the disadvantage that it is inaccurate and the characteristics detected may not in fact match the real interests of the user.

EP 2 341 479 A1 discloses a system and method for providing user control over the network usage data and the personal profile information of the user. In accordance with the method, outbound requests of applications from the internet are continuously logged and forwarded, and incoming requests analyzed, wherein the requested content including any advertising content contained therein is forwarded to the application, but requests for user profile data for downloading additional personalized advertising are extracted and prevented. The usage profile created by the method can be used for loading advertising correlated with it by means of the method itself. The system and method disclosed by EP 2 341 479 A1 allow a partial elimination of personalized advertising from third-party providers and offer protection against the transmission of user profile data to third parties. However, they do not thereby allow a comprehensive blocking of unwanted advertising. The logging of the analyzed network traffic and the generation of a user profile are not required for the prevention of unwanted advertising and uncontrolled accumulation of personal or potentially personal data from third parties, and are unnecessarily expensive. The automated creation of a user profile is also inaccurate and any downloaded advertising based on it might also be unwanted by the user and annoying for him. The implementation of the system and method proposed by EP 2 341 479 A1 is also effected by its installation as software either directly on the user's terminal equipment or on a computer connected to it. This assumes appropriate technical expertise on the part of the user for its installation and configuration.

US 2014/0298445 A1 discloses a method and a device for URL-based filtering of the network traffic. The URL (Uniform Resource Locator) designates the address of a resource on a network, such as a web page. The destinations (URLs) of outbound connection requests are compared with a stored filter list and forwarded if they are not blocked; the incoming responses are compared with the filter list again and forwarded to the client if they do not belong to a blocked category. The filtering of the incoming responses can also include the decoding and examination of the contents on the basis of keywords. The method and device disclosed by US 2014/0298445 A1 enable the elimination of unwanted advertising on the basis of filter lists and a content check, but offer no protection against transmission of user profile data to third parties or the accumulation of personal or potentially personal data from third parties.

### DISCLOSURE OF THE INVENTION

The object of the invention is to avoid the above described disadvantages. The aim of the invention is to provide a separate network device for end consumers, which can be put into operation without technical knowledge, without software installation and with minimal installation effort, and allows all terminals, which are connectable to the domestic local area network, the use of internet-based information and entertainment content without undesired advertising and without uncontrolled transmission of user profile data to third party providers.

The object is achieved according to the invention by a network control device according to claim 1, advantageous embodiments are described in the dependent claims.

The core of the invention is formed by a network control device having at least one data communication interface for wireless or wire-bound data communication with a local area network and having at least one storage device with resource information regarding advertising content and analysis services, wherein the network control device is configured in a separate housing and is programmed for routing the data traffic of at least one client from the local area network to external servers on the internet; for analyzing outbound requests on the application protocol level by identifying resource information regarding advertising content and analysis services and by comparison with the stored resource information; for the unmodified or modified forwarding or blocking of requests to external servers as a function of the result of the analysis or for generating a dedicated response to a blocked request to the client; for the analysis of incoming responses on the application protocol level and identifying resource information and tracking information and for the unmodified or modified forwarding or replacement of the responses to the client as a function of the analysis result. Resource information within the meaning of the invention is information, which represents the addresses of the advertising content or analysis services on the internet (URL=Uniform Resource Locator), and additional metadata of the request or response that are transmitted in the header of the message (HTTP header). The term ‘analysis services’ is defined as meaning any third-party providers who record data about the visitors and web pages visited, hence for example, web analytics or tracking services, social media or advertising networks, media agencies or advertisers. Clients within the meaning of the invention are defined as meaning digital terminal devices which enable internet-based content to be retrieved and displayed in a browser application or an app. Apps here mean other application programs for accessing and displaying internet content for internet-enabled devices, such as smartphone devices or tablet computers. External servers are server services on the internet that provide information and entertainment content for users. Application protocols are taken to mean protocols belonging to the application layer for transferring files from the internet to a client, which are based upon the TCP transport protocol, in particular the Hypertext Transfer Protocol (HTTP). In the analysis of the outbound requests (for example, an HTTP request), in the case of a negative analysis result, that is, if none of the resource information contained in the request matches the stored resource information, the requests are forwarded unchanged to the external server. If the results of the analysis reveal that potential profile data are included in the request—for example, tracking IDs—these are removed and the remainder of the request is forwarded thus modified. In the case of another partially positive analysis result, if the request to the external server is to be diverted via an analysis service—for example a tracking service—the request is forwarded directly to the destination actually intended by the user and identifiable from the remainder of the address information of the request, in appropriately modified form. In the event of a positive analysis result, in other words, if the sole or final destination contained in the request matches a stored resource information, the request is prevented from passing to the external server, for example, to intercept pure tracking signals or to prevent the loading of undesired advertising. If the request consists solely of the request for an identified advertising content, then the network control device generates an immediate response with a neutral content—for example, a picture formed of transparent pixels—and transmits it to the client to prevent the presentation of unwanted advertising and, at the same time, to prevent a malformed display or error message. If the analysis of the incoming requests (for example, an HTTP response) produces a negative analysis result, in other words if none of the resource information contained in the response matches the stored resource information, then the response is forwarded to the client unchanged. If the results of the analysis reveal that potential requests for profile data are contained in the response—for example, a tracking cookie—these are removed and the remainder of the response is forwarded thus modified. In the event of a positive analysis result, that is, if a resource information item contained in the response matches a stored resource information item, hence it is an advertising content item which at the time of the request was not yet able to be identified and filtered out, then this is replaced by neutral content—for example, a picture formed of a transparent pixel—replaced and sent to the client, in order to prevent the display of unwanted advertising and at the same time, to prevent a malformed display or error message. The integration of the network control device can be effected in a simple manner by having its permanently defined or definable IP address defined in an existing DHCP service as a network proxy or default gateway. Alternatively, the permanently defined or definable IP address of the network control device can be manually defined on the clients as a network proxy or default gateway. The invention has the advantage that all terminals that can be connected to the domestic local network are enabled, without software installation and with a minimum installation effort, to use internet-based information and entertainment content without unwanted advertising and without uncontrolled transmission of user profile data to third party providers.

The fact that the network control device is additionally programmed as a DHCP server and its IP address is set as a default gateway, facilitates the integration of the network control device without the need for a separate DHCP server. The network control device in this arrangement assigns dynamic IPv4 addresses to the other terminal devices in the local network according to the DHCP protocol and sets its own IP address as the gateway.

An alternative simplified integration of the network control device is achieved by the network control device being programmed to provide a proxy auto-config file (PAC file) for all clients in the local area network, which enables it to be automatically configured as a browser proxy on the clients.

A fully automatic integration of the network control device is achieved if it is programmed for dispatching ARP requests to all IP addresses in the network segment of the local network, for storing the device-specific MAC addresses and IP addresses of existing terminals that are received as ARP responses, and for regularly dispatching ARP packets to the terminals that define the network control device as an internet access point. The Address Resolution Protocol (ARP) is a network protocol which determines the physical address (hardware address) of the network access layer for any network address on the internet layer, and stores this assignment for a definable period of time in the ARP tables (ARP cache) of the participating computers. In this embodiment, the IP address for the network control device is first either assigned automatically by a DHCP service existing on the local area network, or manually defined. The network control device determines the devices present on the local area network by sending specific requests (so-called ARP requests) to all IP addresses in its network segment of the local area network. The terminals thus addressed each send a response (an ARP response), which contains their device-specific hardware address (MAC address). The network control device stores the mapping from the hardware address to the IP address for each device in a local database. The network control device then periodically sends ARP packets to the terminals, which define the network control device as an internet access point. The ARP packets instruct the terminals to initially send all requests that are directed to the internet to the network control device, which means for these requests in the local area network, it fulfils the role of the internet access point, for example a router. The terminals store this instruction in a local table, known as the ARP cache, for an implementation-dependent time period. The time interval for dispatching the ARP packets to the terminals is chosen in such a way that the instruction is maintained constant throughout for all terminals. This ensures that all terminals in the network segment of the local area network send outbound requests to the network control device instead of to the internet access point physically present in the local network, for example a router. This routes the data traffic via the actual internet access point and analyzes and processes the requests and responses.

The fact that the network control device is implemented with a data communication interface for the cable-bound data communication and with a WLAN interface and is programmed as an access point in addition to its function as an advertising and analysis service blocker, enables the direct integration of wirelessly communicating terminals, such as tablet computers or smartphones. The network control device is integrated into the local area network via the data communication interface for the cable-bound data communication—usually an Ethernet interface—with one of the above-mentioned methods. At the same time, via the integrated WLAN interface the network control device provides a dedicated WLAN as an access point for wireless devices. The network control device can thus act as a bridge between the local area network and the WLAN, so that it uses the same IP address range for the WLAN as in the local network. If the network control device is itself programmed as a DHCP server, it can also manage the WLAN via a separate network domain and supply this with dynamic IP addresses from the address range of the WLAN. In this case, the network control device can be configured in such a way that it provides its function as an advertising and analysis service blocker either for both network domains or for only one of the two network domains.

The network control device is used for the analysis and processing of encrypted HTTPS connections, by virtue of being programmed for installing a root certificate used in the client-side application being used (for example, the browser used); for deploying SSL certificates for connections to clients in the local area network; for the verification of SSL certificates on external servers on the internet, and for encrypted data communication with clients from the local network and with external servers on the internet using the HTTPS protocol. Data transferred via HTTP can be read on all devices (servers, routers, etc.) passed through during the transfer. Therefore, the HTTPS protocol was developed as an additional protocol for encrypted data transfer. Data transferred via HTTPS cannot be easily analyzed or modified by points involved in the transfer process, since the communication between the application on the terminal and the external server on the Internet is encrypted. To support HTTPS, it is necessary for the connection target (server) to provide an SSL certificate and for the client to accept it. In order that the client can establish an HTTPS connection to the network control device, the latter's internal issuing authority certificate (root certificate) must be manually confirmed and installed in a single operation. This process is required no more than once for each client-side application. HTTPS requests of the client are then authenticated via the certificate provided by the network control device and encrypted using the default key exchange of the SSL protocol. Thus, the network control device is able to decrypt, analyze and process the data traffic with the client. The network control device then in turn establishes a new connection to the external destination server via HTTPS. The authentication of the server is performed by the verification of the server certificate of the originating destination server by root certificates of the world-wide and generally accepted certification authorities (CA) installed in the network control device. The key exchange is a standardized process using the SSL protocol, and the data exchange between network control device and an external destination server is encrypted accordingly. In this embodiment, the network control device therefore routes the data traffic between the client and the external server through two separate encrypted connections: one is between the application program on the client and the network control device, and the second is between the network control device and the external server. In the event that the network control device cannot establish the HTTPS connection to the destination server, for example, because the latter's certificate is invalid or not trustworthy, an appropriate error message will be reported back to the client.

A simple facility for modifying the functioning of the network control device is enabled by programming it to have a configuration interface, which the network control device transmits to a client by the insertion of program instructions into responses and which provides modification options for the stored resource information and/or rules relating to the stored resource information that can be stored on the network control device. The deployment of the configuration interface takes place automatically during operation, by corresponding program instructions being embedded in the responses transmitted to the client, which can be displayed together with the transmitted content in the respective application program being used on the client. If the client's request, for example, relates to a web page, corresponding HTML/Javascript components are embedded in the incoming HTML responses, which display the available options of the configuration interface in the browser application on the client in the requested web page—for example in an additional menu bar. With the aid of the configuration interface, modifications to the resource information can be made, for example, entries can be added, updated or removed. In addition or alternatively, the configuration interface is designed for inputting storable rules in relation to the resource information—such as the definition of filter rules, for example the whitelisting or blacklisting of individual addresses. Possible rules are, for example, the definition of an exception for a particular URL, so that all content and tracking requests referenced by this URL are freely downloaded, or the definition of an exception for certain content providers or tracking services, so that all content and tracking requests from these services are freely downloaded, or the general definition of a positive authorization of HTTP requests only to certain servers, or the definition of a general prohibition of HTTP requests to specific servers.

In the above embodiment, a user-specific configuration of the functioning of the network control unit is enabled by the network control device being programmed with a user account management feature, wherein each user is assigned a user account via an authentication function and a separate configuration profile is assigned to each user account. This allows the definition of personalized user profiles, with which each user can adapt the functioning of the network control device easily and centrally to his/her personal needs, in other words, for example, can enable specific resources for use or disable other resources from being used. A simple version of the authentication function is effected by the permanent fixed assignment of a specific device to a user account, for example on the basis of its MAC address. The respective user account and the corresponding configuration profile will become active as soon as the device logs on to the local network. A cross-device authentication function is easily provided, for example, by a user name/password check or PIN-verified input or PIN verification. In this system, following a successful authentication, the user opens a new session which is assigned to the user. The session is automatically terminated after a definable period of time if no further requests are input in this session context (timeout).

In the above embodiment, parallel global and user-specific configuration settings are enabled, by the network control device being programmed with a plurality of user accounts, for which different modification and rule permissions are defined, and in addition to personal configuration profiles, one or a plurality of global configuration profiles are defined.

Possible user account types with different modification and rule permissions are, for example, administrator, adult, guest, young person, or child. The user account type specifies default preferences and defines which settings the user can change him/herself and which he/she cannot. In addition to the security related benefits that are achieved by allowing basic filter functions to only be modified by user account types with appropriate rights, this also enables the implementation of a parental control policy, by access generally only being allowed to certain servers or access to certain servers being prevented for young people's or children's account types.

In the two previous embodiments, an additional usage advantage is achieved by the network control device being programmed to store user profile data that can be entered by the user in user accounts; for forwarding this user profile data to user-definable external servers, which offer personalized advertising content, wherein the network control device defines a selection of possible servers for the user from a locally stored, manually or automatically updatable database with resource information; receiving personalized advertising content, based on the forwarded user profile data and for forwarding this advertising content to the client, wherein the advertising content items are transmitted to a client by the insertion of program instructions into responses and are displayed in a definable region of the display area of the client-side application. Users who would like to receive controllable and targeted advertising oriented to their actual interests and socio-demographics can in this embodiment activate this feature via the user account management function of the network control device. To do this, they first need to store user profile data in the invention corresponding to their current interests, which are assigned to and stored in their user account. Specifically, these can be the following data, for example, wherein the definitions of the features are usually retrieved in standardized form from a selection list specified by the network control device, which can include, for example, the following information about the interest profile of the user:

A. Socio-demographic data
age
gender
occupational status and occupation
marital status
number of children in the household
household income
professional training
personal net income

B. Personal interests
1. Cosmetics and fashion
cosmetics and body care products
glasses
fashion and clothing,
watches and jewelry
accessories (handbags, purses, etc.)
2. Consumer Electronics
computers (hardware or software)
TV
mobile communications (mobile phone, smartphone, etc.)
HiFi
3. Finances, insurance and real estate
financial investments
insurance policies
real estate
4. House & garden
DIY articles and equipment
energy supply (electricity, gas, water)
internal decor
pet supplies
horticulture
household appliances
baby items and baby equipment
5. Lifestyle, travel and leisure
arts and culture,
sports and Fitness
travel
6. Mobility
Public transport, flight or rail offers
car sharing
automotive (new vehicle models and trends)
7. Education
Training, further and higher education

C. Intent (current interests and plans)
Acquisition of a motor vehicle
Property purchase
Planned relocation
Partner matching services
Legal advice
Medical advice

Via a regular automated update, the network control device receives a list of advertising partners (URLs of advertising servers) to which the stored user profile data can be disclosed. This list can be viewed and individually configured by the user of the invention (enabling/blocking of advertising partners). The changes made are saved permanently in the respective user profile. Based on the user profile data—for example, on the basis of RTA—personalized advertising contents are then received by the network control device and forwarded to the client. In this case, the network control device embeds corresponding program instructions in the responses transmitted to the client, by means of which the advertising content is displayed in a definable region of the display area of the client-side application. This can be, for example, a defined region above a website which is actually loaded (and cleared of advertising by the invention). The user has the option to individually determine the display position of the personalized advertising content within the application being used. The user therefore benefits from the targeted advertising which he/she can always find at the same place, even though the loaded web page was cleared of other advertising by the network control device. The user has the option at any time to view and edit the list of advertisers to whom his user profile data are transferred. The user profile data specified by the user are transmitted exclusively to the advertising companies selected by the user. This can involve the use of different methods—including in combination—such as embedding the user profile data in the source code of a web page loaded on the client side by the network control device, transmission of the user profile data in the retrieval of an advertising URL (via a GET command), transmission of a unique user ID by embedding it into the source code or transmission of a unique user ID by setting an advertiser-specific cookie. On the basis of the transmitted user profile data, the advertising partner determines (for example via RTA) the advertising which is best suited to the user profile and delivers it to an advertising URL provided for the purpose.

In the above embodiment, an increase in the relevance of the personalized advertising content is achieved by the fact that the user profile data enterable by the user include relevance assessments of specific advertising content already received. For this purpose, a rating scale consisting of five stars, which is overlaid outside of the advertising display area, is displayed to the user, for example, when moving the mouse over the advertising content (roll-over). If the user clicks on one of the five stars, he/she has the option to also select a reason for the evaluation from a list of predefined reasons, in addition to their own rating. The user rating of the advertising content is stored in the user profile and in future is sent to a rating server along with the other user profile data.

The fact that the network control device is programmed for routing the data traffic to external servers on the internet via an anonymizing network achieves complete anonymization of the user. Such IP-anonymization networks, such as the Tor network, disguise the origin of the user and hide their actual IP address. This also prevents a traceable logging of the retrieval of media content by the user directly on the respective source provider (content provider or publisher).

Further measures which improve the invention are described in greater detail below together with the description of preferred exemplary embodiments and by reference to the figures. Shown are:

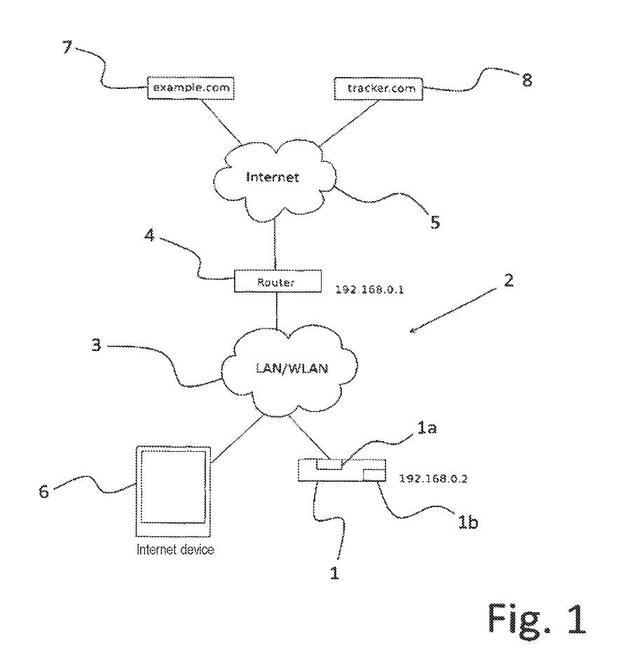

FIG. 1 a schematic illustration of a network control device within a network installation.

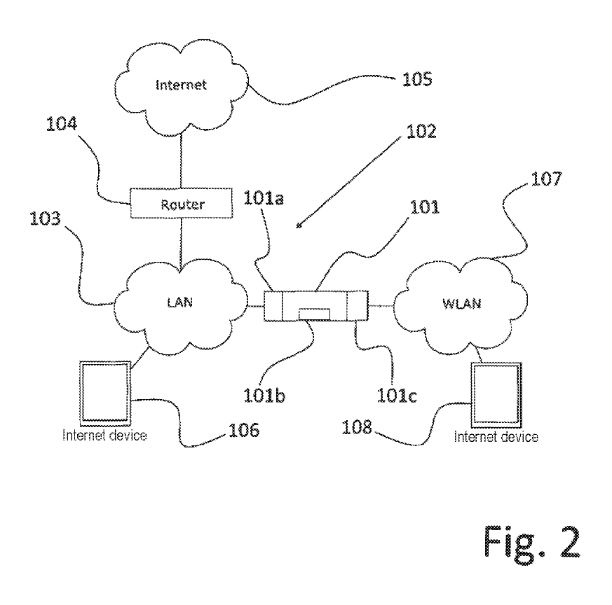

FIG. 2 a schematic illustration of a further network control device within a further network installation.

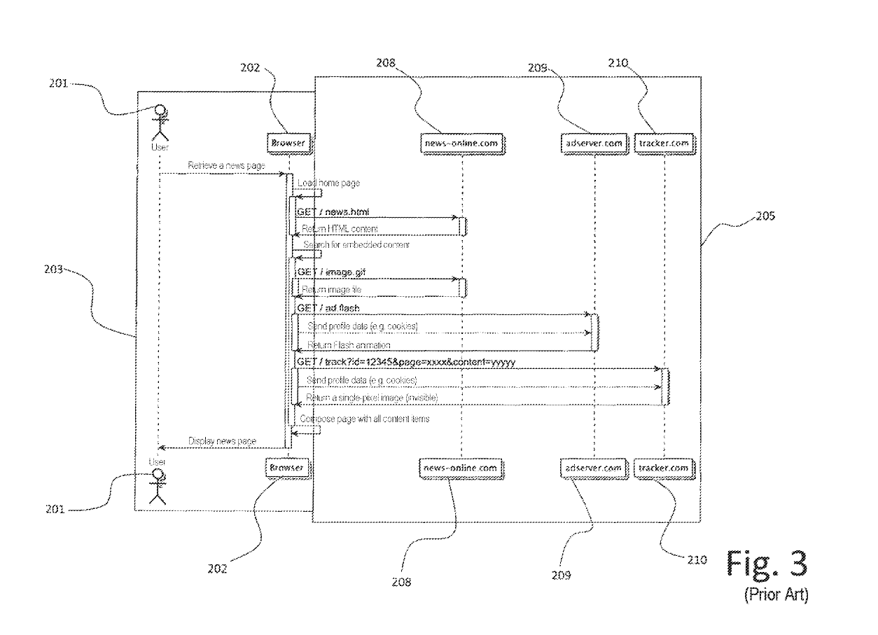

FIG. 3 a standard data communication process from the prior art

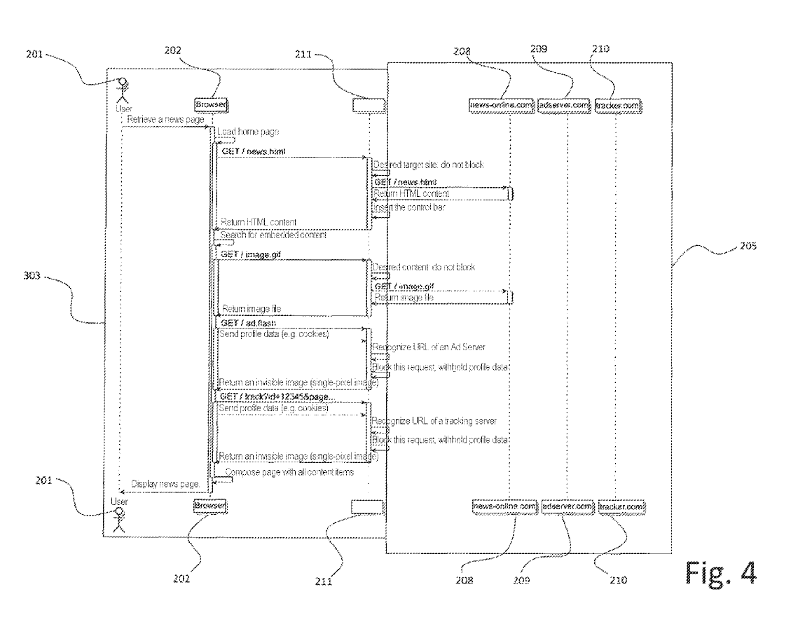

FIG. 4 illustrates a data communication process involving a network control device.

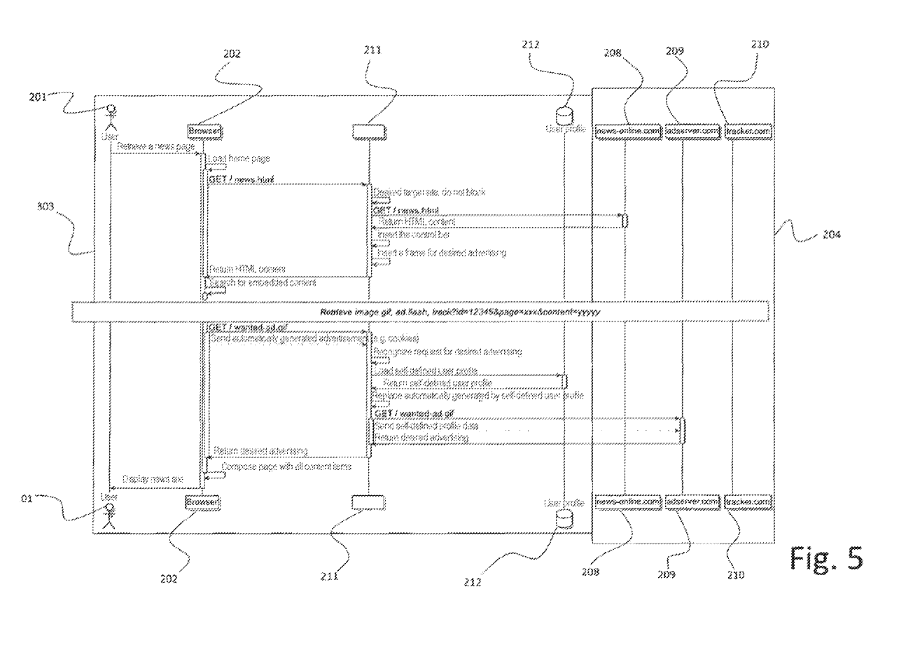

FIG. 5 shows a further data communication process involving a network control device.

FIG. 1 shows a schematic representation of the network control device 1 with an Ethernet interface 1a for cable-bound data communication and a storage device 1b within a network installation 2. The local area network 3 includes the router 4, which at the same time mediates the access to the internet 5 for terminal devices from the local area network 3. The router 4 has the fixed address 192.168.0.1 and at the same time provides a DHCP service in the local network 3, with which it assigns dynamic IPv4 addresses to terminals in the network 3 according to the DHCP protocol. The network control device 1 is connected to the local network 3 via the Ethernet interface 1a and can be accessed under the fixed IPv4 address 192.168.0.2 and is set as a gateway in the DHCP responses of the router 4. The user would like to load the site http://example.com/ on the terminal 6. The active browser application on the terminal 6 then creates a request (HTTP request) of the form:

### GET/HTTP/1.1

Host: example.com
Accept: text/html

The router 4 forwards the request to the network control device 1. The network control device 1 checks whether a matching filter rule for the URL http://example.com/ exists in the storage device 1a. If this is the case and the rule prohibits the user's access to the URL, then the network control device 1 creates a response (HTTP response) with an HTML error page:

### HTTP/1.1 402 Forbidden

Content-Type: text/html
. . .

If the URL is allowed, the network control device 1 forwards the HTTP request for the given URL via the router 4 to the web server 7 that is addressable via the URL example.com on the internet 5.

The web server 7 responds with an HTTP response, which contains an HTML page:

### HTTP/1.1 200 OK

Content-Type: text/html
. . .

The network control unit 1 checks whether program instructions will be inserted into the HTML page obtained, based on the permissions and settings of the active user account for the terminal 6.

Based on the corresponding permissions and configuration settings, the network control device 1 inserts the HTML and JavaScript code into the HTML page for displaying an expandable and hideable control bar for access to the personal configuration profile of the user account and for displaying personalized advertising content:
a DIV element as a container for the control bar, which is initially hidden by CSS instruction.
Icon for displaying or hiding the control bar, which is fixed at the top edge of the page via the CSS instruction “position:fixed”.
JavaScript code with at least one of the following functionalities: if the icon of the control bar is clicked, an IFrame element is inserted in the DIV container, and the DIV container is made visible using a CSS instruction. The IFrame element has the URL http://192.168.0.2/controlbar as a source attribute.

The active browser application on the terminal 6 receives the modified HTML page from the network control device 1 and to assemble the page, places HTTP requests for the resources referenced in the page, such as images and scripts.

The HTML page sent to the terminal device 6 references the image image.png as a resource. The active browser application on the terminal 6 places the following HTTP request, which is sent to the network control device 1:

### GET/image.png HTTP/1.1

Host: example.com
Accept: image/*
Referrer: http://example.com/

The network control unit 1 searches in the storage device 1a for a suitable filter rule, but does not find one.

The network control device 1 forwards the unchanged request via the router 4 to the web server 7 addressable on the internet 5 via the URL example.com.

The web server 7 answers with a response, which contains an image:

### HTTP/1.1 200 OK

Content-Type: image/png

The network control device 1 does not modify the response because it is not an HTML page.

The active browser application on the terminal 6 receives the image file and displays it.

The HTML page sent to the terminal device 6 references the image 1x1.gif as an additional resource. The active browser application on the terminal 6 places the following HTTP request, which is sent to the network control device 1:

GET /1x1 .gif?id=12345678 HTTP/1.1
Host: tracker.com
Accept: image/*
Referrer: http://example.com

The network control device 1 finds a matching filter rule in storage device 1a for the tracking service tracker.com, which states that the URL should be blocked.

The network control device 1 creates a separate HTTP response, which contains an image of a transparent pixel:

### HTTP/1.1 200 OK

Content-Type: image/gif

The web server 8 addressable on the internet 5 via the URL tracker.com was not queried, and it could not therefore collect any information about the retrieval of http://example.com/.

The active browser application on the terminal 6 receives the image file. The layout of the HTML page does not change, since the image is only a transparent pixel.

To use the control bar, the user clicks on the control bar icon. The JavaScript code inserted into the HTML page by the network control device 1 is executed and creates an IFrame element.

The active browser application on the terminal 6 places a request to the URL specified in the IFrame element:

### GET/controlbar HTTP/1.1

### Host: 192.168.0.2

Accept: text/html

The router 4 forwards the request to the network control device 1. This creates an HTML page that also contains, for example, the number of trackers that have been blocked on the currently loaded page.

The network control device 1 sends an HTTP response with the generated HTML page

### HTTP/1.1 200 OK

Content-Type: text/html

The active browser application on the terminal 6 displays the received HTML page in the IFrame as a control bar.

Optionally, by clicking on elements such as buttons or check boxes, the user can modify the global configuration settings of the network control device 1. The user action triggers corresponding HTTP requests in the browser application via XMLHttpRequest (AJAX), which the network control device 1 processes.

FIG. 2 shows a schematic representation of the network control device 101 with a storage device 101b within a network installation 102. The local area network 103 includes the router 104, which at the same time mediates the access to the internet 105 for terminal devices from the local area network 103 and the terminal 106 which is connected to the local area network 103 by cable. At the same time, the router 104 provides a DHCP service in the local network 103, with which it assigns dynamic IPv4 addresses to terminals in the network 103 according to the DHCP protocol. The network control device 101 has an Ethernet interface 101a for data communication for cable-bound data communication and a WLAN interface 101c for wireless data communication. The network control device 101 is programmed as an access point and provides access to the WLAN 107 for wireless devices via the WLAN interface 101b. The network control device 101 thus acts as a bridge between the local area network 103 and the WLAN 107, so that it uses the same IP address range for the WLAN 107 as in the local area network 103.

FIGS. 3 to 5 show different data communication processes in network connections with and without a network control device.

FIG. 3 shows a typical data communication process from the prior art between the user 201 of a browser application 202 in the local network 203 and the web server 208, which is addressable on the internet 204 via the URL news-online.com, the web server 209 which is addressable on the internet 204 via the URL adserver.com and the web server 210 addressable on the internet 204 via the URL tracker.com without an active network control device in the local network 203. In the first step, the user 201 retrieves the news website news-online.com via their browser 202. After loading the main page news.html and the image file image.gif referenced in the home page from the web server 208, the browser 202 downloads the additional advertising content ad.flash referenced in the main page news.html from the web server 209, wherein it transfers user profile data to the web server 209. Then, the browser 202 executes the additional tracking code track?id=12345&page=xxxx&content=yyyyy to the web server 210, a tracking service, referenced in the home page news.html, wherein it sends user profile data to the web server 210. The web server 210 sends an invisible single-pixel image back to the browser 202. After receiving all the referenced content in the home page news.html, the browser 202 composes the page (rendering) and displays it. The home page news.html is displayed to the user 201 with the advertising content ad.flash.

FIG. 4 shows an alternative data communication process between the user 201, the browser application 202 in the local area network 303 and the web server 208, which is addressable on the internet 204 via the URL news-online.com, the web server 209 which is addressable on the internet 204 via the URL adserver.com and the web server 210 addressable on the internet 204 via the URL tracker.com with the network control device 211 activated in the local network 203. In the first step, the user 201 retrieves the news website news-online.com via their browser 202. The browser 202 requests the home page news.html, the request being sent to the network control device 211. The network control device 211 searches for a matching filter rule but does not find one, it therefore forwards the unchanged request to the web server 208 and delivers the home page news.html received in response to the browser 202. At the same time, the network control device 211 inserts HTML and JavaScript code into the HTML page for displaying a control bar to access the personal configuration profile of the user account. Thereafter the browser 202 requests the image file image.gif referenced in the home page from the web server 208. The network control device 211 searches for a matching filter rule but does not find one, it therefore forwards the unchanged request to the web server 208 and delivers the image file image.gif received in response to the browser 202. Then, the browser 202 requests the additional advertising content ad.flash referenced in the home page news.html, from the web server 209. The network control device 211 finds a matching filter rule for the URL adserver.com, blocks the request and creates a separate HTTP response with which it delivers an image consisting of a transparent pixel to the browser 202. At the same time, this blocks the transmission of user profile data to the web server 209. Then, the browser 202 requests the additional tracking code track?id=12345&page=xxxx&content=yyyyy referenced in the home page news.html from the web server 210. The network control device 211 finds a matching filter rule for the URL tracker.com, blocks the request and creates a separate HTTP response with which it delivers an image consisting of a transparent pixel to the browser 202. At the same time, this blocks the transmission of user profile data to the web server 210. After receiving all of the referenced content in the home page news.html, the browser 202 composes the page (rendering) and displays it. The start page news.html is displayed to the user 201 without the advertising content ad.flash and without sending profile data unnoticed to third parties.

FIG. 5 shows an alternative data communication process between the user 201, the browser application 202 in the local area network 303 and the web server 208, which is addressable on the internet 204 via the URL news-online.com, the web server 209 which is addressable on the internet 204 via the URL adserver.com and the web server 210 addressable on the internet 204 via the URL tracker.com, with the network control device 211 activated in the local network 203 and with the active user profile 212 with user profile data for the user 201. In the first step, the user 201 retrieves the news website news-online.com via their browser 202. The browser 202 requests the home page news.html, the request being sent to the network control device 211. The network control device 211 searches for a matching filter rule but does not find one, and therefore forwards the unchanged request to the web server 208, and delivers the home page news.html received in response to the browser 202. At the same time, the network control device 211 inserts HTML and JavaScript code into the HTML page for displaying a control bar to access the personal configuration profile of the user account and for displaying personalized advertising content according to the content and settings of the user profile 212 with user profile data. The retrievals of the contents referenced in the home page, namely image.gif, ad.flash and the tracking request track?id=12345&page=xxxx&content=yyyyy are not listed separately in FIG. 5, they proceed as illustrated in FIG. 4. In deviation from the illustration in FIG. 4, however, according to the procedure of FIG. 5 the browser 202 starts an additional request wanted-ad.gif for personalized advertising in accordance with the contents and settings of the user profile 212 with user profile data from the network control device 211. The network control device 211 retrieves the user profile 212 with user profile data self-defined by the user 201 and loads this. The network control device 211 then executes a request for a personalized advertising content to the web server 209 and transfers the user profile data of the user profile 212. The network control device 211 contains as a response an item of advertising content desired in accordance with the user profile data and delivers it to the browser 202. After receiving all the referenced content in the home page news.html, and all of the personalized advertising content, the browser 202 composes the page (rendering) and displays it. In this case, in addition to the home page news.html (without the advertising content ad.flash), the desired advertising content is displayed to the user 201 within the display area defined by him/her in the settings of the user profile 212.

### LIST OF REFERENCE NUMERALS

1, 101, 211 network control device
1b, 101b storage device
2, 102 network installation
3, 103, 203, 303 local area network
4, 104 router
5, 105, 205 internet
6, 106, 108 terminal
7, 8, 208, 209, 210 web server
1a, 101a Ethernet interface
101b WLAN interface
107 WLAN
201 user
202 browser application

1. A network control device having at least one data communication interface for wireless or cable-bound data communication with a local area network and at least one memory device with resource information concerning items of advertising content and analysis services, wherein
the network control device is implemented in a separate housing and is programmed for
routing of the data traffic of at least one client from the local area network with external servers on the internet;
analysis of outbound requests on the application protocol level by identification of resource information concerning items of advertising content and analysis services and comparison with the stored resource information;
unmodified or modified forwarding or blocking of requests to external servers, depending on the analysis results or generation of a separate response to a blocked request to the client;
analysis of incoming responses on the application protocol level and identification of resource information and tracking information;
unmodified or modified forwarding or replacement of the responses to the client, as a function of the analysis results.

2. The network control device as claimed in claim 1, wherein
the network control device is programmed as a DHCP server and its IP address is set as the default gateway.

3. The network control device as claimed in claim 1, wherein
the network control device is programmed to provide a PAC file for all clients in the local network, by means of which it is automatically configured as a browser proxy on the clients.

4. The network control device as claimed in claim 1, wherein
the network control device is programmed for dispatching ARP requests to all IP addresses in the network segment of the local area network, for storing the device-specific MAC addresses and IP addresses of existing terminals that are received as ARP responses, and for regularly dispatching ARP packets to the terminals, which define the network control device as an internet access point.

5. The network control device as claimed in claim 1,
having a data communication interface for cable-bound data communication and having a WLAN interface, wherein the network control device is programmed as an access point.

6. The network control device as claimed in claim 1, wherein
the network control device is programmed for
installation of a root certificate in a client-side application;
deployment of SSL certificates for connections to clients in the local area network;
verification of SSL certificates of external servers on the internet, and
for encrypted data communication with clients from the local area network and with external servers on the internet using the HTTPS protocol.

7. The network control device as claimed in claim 1, wherein
the network control device is programmed with a configuration interface, which the network control device transfers to a client by the insertion of program instructions into responses, and which provides modification options for the stored resource information and/or rules relating to the stored resource information that can be stored on the network control device.

8. The network control device as claimed in claim 7, wherein
the network control device is programmed with a user account management, wherein each user is assigned a user account via an authentication function and each user account is assigned a separate configuration profile.

9. The network control device as claimed in claim 8, wherein
the network control device is programmed with a plurality of user accounts, for which different modification and rule permissions are defined, and in addition to personal configuration profiles, one or a plurality of global configuration profiles are defined.

10. The network control device as claimed in claim 8, wherein
the network control device is programmed for
storage in user accounts of user profile data which can be entered by the user;
transmission of these user profile data to external servers which can be defined by the user and which offer personalized advertising content, wherein the network control device defines a selection of possible external servers for the user from a locally stored, manually or automatically updatable database with resource information;
reception of personalized advertising content, based on the forwarded user profile data;
forwarding this advertising content to the client, wherein the advertising content items are transmitted to a client by the insertion of program instructions into responses and are displayed in a definable region of the display area of the client-side application.

11. The network control device as claimed in claim 10, wherein
the user profile data which can be entered by the user contain relevance assessments of specific, already received advertising content.

12. The network control device as claimed in claim 1, wherein
the network control device is programmed for routing the data traffic to external servers on the internet via an anonymizing network.
